(19) United States
(12) Patent Application Publication
(10) Pub. No.: US 2015/0349599 A1
(43) Pub. Date: Dec. 3, 2015

(54) STATOR COIL FOR ROTATING ELECTRIC MACHINE, METHOD FOR MANUFACTURING THE STATOR COIL, AND ROTATING ELECTRICAL MACHINE

(71) Applicant: MITSUBISHI ELECTRIC CORPORATION, Chiyoda-ku, Tokyo (JP)

(72) Inventors: Shigeyuki YAMAMOTO, Chiyoda-ku (JP); Kozue ISOZAKI, Chiyoda-ku (JP); Kazuki KUBO, Chiyoda-ku (JP); Atsuhiko FUNAKI, Chiyoda-ku (JP)

(73) Assignee: MITSUBISHI ELECTRIC CORPORATION, Chiyoda-ku, Tokyo (JP)

(21) Appl. No.: 14/652,231

(22) PCT Filed: Dec. 25, 2013
(86) PCT No.: PCT/JP2013/084742

§ 371 Date: Jun. 15, 2015

(30) Foreign Application Priority Data
Jan. 7, 2013 (JP) 2013-000655

(51) Int. Cl. H02K 3/30; H02K 3/32; H02K 15/02

(52) U.S. Cl. CPC H02K 3/30; H02K 15/026; H02K 3/32

(57) ABSTRACT

A stator coil for a rotating electrical machine, the stator coil including a stator iron core and a coil formed by winding an enamel wire around a slot of the stator iron core, in which the enamel wire is covered with a cured product of a first insulating varnish containing a polyester resin and the coil is covered with a cured product of a second insulating varnish containing an epoxy acrylate resin. The stator coil for a rotating electrical machine has an insulating layer with excellent adhesive strength to prevent thermal degradation of its enamel wire and has excellent dielectric strength properties retained for an extended period of time.

### TECHNICAL FIELD

The present invention relates to a stator coil for a rotating electrical machine, a method for producing the stator coil, and a rotating electrical machine.

### BACKGROUND ART

A stator coil for a rotating electrical machine is formed by winding an enamel wire around a slot of a stator iron core (core), impregnating the resulting coil (wound wire) with an insulating resin composition (insulating varnish), and then subjecting the resultant to thermosetting to form an insulating layer, so as to enhance the insulating properties of the coil.

A stator coil for a rotating electrical machine is sometimes exposed to high voltages and is therefore required to withstand high voltages for an extended period of time. To meet this need, Patent Document 1 suggests a stator coil excellent in dielectric strength properties formed by providing a conductive coating to the surface of an enamel wire having a polyamide-imide coating as an enamel coating or to the surface of a coil prepared by winding the enamel wire.

A stator coil for a rotating electrical machine is also subjected to exposure to high temperatures for an extended period of time and is therefore also required to be less susceptible to thermal degradation.

In the stator coil of Patent Document 1, however, the compatibility between the enamel coating and the conductive coating is poor, leading to inadequate adhesive strength imparted to the conductive coating. Because of this, when exposed to high temperatures for an extended period of time, the enamel wire deteriorates, resulting in defective insulation and degradation in the dielectric strength properties, which presents a problem.

To solve this problem, Patent Document 2 suggests a stator coil formed by providing, to the surface of an enamel wire having a polyamide-imide coating or to the surface of a coil prepared by winding the enamel wire, with a THEIC-modified polyester resin coating that has been modified with an oil component having a double bond.

### REFERENCE

### Patent Documents

Patent Document 1: JP 2004-254457 A

Patent Document 2: JP 4475470 B

### DISCLOSURE OF THE INVENTION

### Problems to be Solved by the Invention

The stator coil of Patent Document 2, however, is insufficient in the crosslink density in the THEIC-modified polyester resin coating that serves as an insulating layer and therefore fails to maintain excellent dielectric strength properties for an extended period of time, which presents a problem.

Here, the present invention is devised so as to solve these problems. An object of the present invention is to provide a stator coil for a rotating electrical machine, the stator coil having an insulating layer with excellent adhesive strength to prevent thermal degradation of its enamel wire and having excellent dielectric strength properties retained for an extended period of time; a method for producing the stator coil; and a rotating electrical machine having these properties.

### Means for Solving the Problems

The inventors of the present invention conducted intensive research to solve these problems and, as a result, found that, by covering an enamel wire or a coil of a wound enamel wire with a cured product of an insulating varnish containing a polyester resin and then covering the cured product of an insulating varnish containing a polyester resin with a cured product of an insulating varnish containing an epoxy acrylate resin so as to form an insulating layer, improvement can be made in not just the adhesive strength of the insulating layer, but also the long-term dielectric strength properties, thus, completing the present invention.

That is, the present invention provides a stator coil for a rotating electrical machine, the stator coil including a stator iron core and a coil formed by winding an enamel wire around a slot of the stator iron core, in which the enamel wire is covered with a cured product of a first insulating varnish containing a polyester resin, and the coil is covered with a cured product of a second insulating varnish containing an epoxy acrylate resin.

The present invention also provides a method for producing a stator coil for a rotating electrical machine, the method including applying a first insulating varnish containing a polyester resin to an enamel wire and then winding the enamel wire around a slot of a stator iron core to form a coil, and applying a second insulating varnish containing an epoxy acrylate resin to the coil.

The present invention further provides a method for producing a stator coil for a rotating electrical machine, the method including winding an enamel wire around a slot of a stator iron core to form a coil, applying a first insulating varnish containing a polyester resin to the coil and performing heating, and applying, to the coil obtained by application of the first insulating varnish and heating, a second insulating varnish containing an epoxy acrylate resin and performing heating.

The present invention even further provides a rotating electrical machine that includes the stator coil for a rotating electrical machine.

### Effects of the Invention

The present invention can provide a stator coil for a rotating electrical machine, the stator coil having an insulating layer with excellent adhesive strength to prevent thermal degradation of its enamel wire and having excellent dielectric strength properties retained for an extended period of time; a method for producing the stator coil; and a rotating electrical machine having these properties.

### BRIEF DESCRIPTION OF THE DRAWINGS

FIG. 1 is a graph showing adhesive strength, initial breakdown voltage, and breakdown voltage after 20 days at 260° C. in examples and a comparative example.

### BEST MODE FOR CARRYING OUT THE INVENTION

### Embodiment 1

The stator coil for a rotating electrical machine of this embodiment includes a stator iron core and a coil formed by winding an enamel wire around a slot of the stator iron core. The stator iron core and the enamel wire are not particularly limited and ones that are known in the technical field can be used. A preferable enamel wire among these is an enamel wire having an enamel coating on its polyamide-imide coating.

The enamel wire is provided with a polyester resin coating that is formed by curing a first insulating varnish containing a polyester resin, and, in addition, the coil is provided with an epoxy acrylate resin coating that is formed by curing a second insulating varnish containing an epoxy acrylate resin.

The polyester resin coating on the enamel wire is effective as a stress mitigation layer and a layer to impart adhesive properties, as explained in the following. The polyester resin coating is not as hard as the epoxy acrylate resin coating that is the outermost layer and therefore can contribute to mitigating the stress between the enamel wire and the epoxy acrylate resin coating. In addition, the polyester resin coating has excellent compatibility with the enamel coating, and also has excellent compatibility with the epoxy acrylate resin coating because of the presence of an ester group therein that is also present in the epoxy acrylate resin coating. This contributes to enhanced adhesion between the enamel wire and the epoxy acrylate resin coating.

Further, the epoxy acrylate resin coating that is the outermost layer has high crosslink density compared to the polyester resin coating, and this allows dielectric strength properties to be enhanced.

For these reasons, by providing the enamel wire with the polyester resin coating that is formed by curing the first insulating varnish containing a polyester resin and then providing the coil with the epoxy acrylate resin coating that is formed by curing the second insulating varnish containing an epoxy acrylate resin so as to form the insulating layer, the adhesive strength of the insulating layer can be enhanced enough to prevent thermal degradation of the enamel wire and excellent dielectric strength properties can be retained for an extended period of time.

The thickness of the polyester resin coating is not particularly limited and is preferably lower than 1 mm. When the thickness of the polyester resin coating is 1 mm or greater, the motor of the resulting rotating electrical machine may not have adequate power output.

The polyester resin contained in the first insulating varnish that constitutes the polyester resin coating is generally a resin obtained by subjecting a polyhydric alcohol to polycondensation (esterification) with an unsaturated polybasic acid and/or a saturated polybasic acid and dissolving the resulting compound (polyester) in a crosslinking agent.

The polyhydric alcohol is not particularly limited and a known polyhydric alcohol can be used. Examples of the polyhydric alcohol include ethylene glycol, propylene glycol, butanediol, diethylene glycol, dipropylene glycol, triethylene glycol, pentanediol, hexanediol, neopentanediol, hydrogenated bisphenol A, bisphenol A, and glycerol. These can be used alone or as a combination thereof.

The unsaturated polybasic acid is not particularly limited and a known unsaturated polybasic acid can be used. Examples of the unsaturated polybasic acid include maleic anhydride, fumaric acid, citraconic acid, and itaconic acid. These can be used alone or as a combination thereof.

The saturated polybasic acid is not particularly limited and a known saturated polybasic acid can be used. Examples of the saturated polybasic acid include phthalic anhydride, isophthalic acid, terephthalic acid, HET acid, succinic acid, adipic acid, sebacic acid, tetrachlorophthalic anhydride, tetrabromophthalic anhydride, and endomethylene tetrahydrophthalic anhydride. These can be used alone or as a combination thereof.

The polyester can be synthesized by a known method using the raw materials exemplified above. Although the conditions of the synthesis must be appropriately selected depending on the kinds and amounts of raw materials used, the esterification can generally be performed in a stream of an inert gas such as nitrogen at a temperature of 140 to 230° C. under pressure or under reduced pressure. In this esterification reaction, an esterification catalyst can be used where appropriate. Examples of the catalyst include known catalysts such as manganese acetate, dibutyltin oxide, stannous oxalate, zinc acetate, and cobalt acetate. These can be used alone or as a combination thereof.

In the synthesis of the polyester, together with the raw materials exemplified above, an epoxy resin, an imide resin, a silicone resin, trishydroxyethyl isocyanurate, or the like may be used. The amount of such a component is not particularly limited and may be appropriately selected depending on the kind of components used. A polyester prepared by using each of these components is an epoxy-modified polyester, an imide-modified polyester, a silicone-modified polyester, or a THEIC (trishydroxyethyl isocyanurate)-modified polyester, respectively. These modified polyesters are particularly preferable due to their ability to stably provide the effects of the present invention, and THEIC-modified polyester is most preferred.

The crosslinking agent is not particularly limited provided that it contains a polymerizable double bond that can undergo polymerization with a polyester. Examples of the crosslinking agent include styrene monomers, diallyl phthalate monomers, diallyl phthalate prepolymers, methyl methacrylate, and triallyl isocyanurate. These can be used alone or as a combination thereof.

The content of the crosslinking agent in the polyester resin is preferably 25 to 70% by mass and more preferably 35 to 65% by mass. When the content of the crosslinking agent is lower than 25% by mass, the viscosity of the resin may increase to impair workability, while when the content of the crosslinking agent exceeds 70% by mass, the resulting cured product may fail to have the desired physical properties.

The thickness of the epoxy acrylate resin coating is not particularly limited and may be appropriately selected depending on, for example, the size of a stator coil to form.

The epoxy acrylate resin contained in the second insulating varnish that constitutes the epoxy acrylate resin coating is not particularly limited and an epoxy acrylate resin that is known in the technical field can be used. Examples of the epoxy acrylate resin include bisphenol A epoxy acrylate, bisphenol F epoxy acrylate, modified bisphenol A epoxy acrylate, modified bisphenol F epoxy acrylate, brominated bisphenol A epoxy acrylate, and brominated bisphenol F epoxy acrylate. These can be used alone or as a combination thereof.

The second insulating varnish can contain a reactive diluent and a reaction initiator together with the epoxy acrylate resin.

The reactive diluent is not particularly limited and a reactive diluent that is known in the technical field can be used. Examples of the reactive diluent include styrene monomers such as styrene, α-, o-, m-, and p-alkyl, nitro, cyano, amide, and ester derivatives of styrene, chlorostyrene, vinyltoluene, and divinylbenzene; dienes such as butadiene, 2,3-dimethylbutadiene, isoprene, and chloroprene; (meth)acrylic acid esters such as ethyl (meth)acrylate, methyl (meth)acrylate, n-propyl (meth)acrylate, isopropyl (meth)acrylate, hexyl (meth)acrylate, 2-ethylhexyl (meth)acrylate, lauryl (meth)acrylate, dodecyl (meth)acrylate, cyclopentyl (meth)acrylate, cyclohexyl (meth)acrylate, tetrahydrofuryl (meth)acrylate, acetoacetoxyethyl (meth)acrylate, dicyclopentenyloxyethyl (meth)acrylate, phenoxyethyl (meth)acrylate, 2-hydroxyethyl (meth)acrylate, 2-hydroxypropyl (meth)acrylate, and 4-hydroxybutyl (meth)acrylate; (meth)acrylamides such as (meth)acrylamides and N,N-dimethyl (meth)acrylamide; vinyl compounds such as (meth)acrylic anilide; unsaturated dicarboxylic acid diesters such as diethyl citraconate; monomaleimide compounds such as N-phenylmaleimide; and N-(meth)acryloylphthalimide. Preferable among these from the viewpoint of workability, cost, and curing properties is styrene.

The content of the reactive diluent in the second insulating varnish is not particularly limited and is generally 20% by mass to 80% by mass and more preferably 30% by mass to 60% by mass.

The reaction initiator is not particularly limited and a reaction initiator that is known in the technical field can be used. Examples of the reaction initiator include organic peroxides, for example, organic hexyl peroxides such as tert-hexyl hydroperoxide, organic acyl peroxides such as benzoyl peroxide, organic ester peroxides such as tert-butylperoxybenzoate, organic hydroperoxides such as tetramethylbutyl hydroperoxide, and organic dialkyl peroxides such as dicumyl peroxide.

The content of the reaction initiator in the second insulating varnish is not particularly limited and is generally 0.1 to 5% by mass and preferably 0.5 to 3% by mass.

In the following, a method for producing the stator coil for a rotating electrical machine of this embodiment is explained.

First, the first insulating varnish is applied to the enamel wire, which is then wound around a slot of the stator iron core to form a coil.

The method of application of the first insulating varnish is not particularly limited and a method known in the technical field can be employed. For example, the enamel wire may be impregnated with the first insulating varnish in a container. Examples of the method of impregnation include vacuum impregnation, vacuum pressure impregnation, and impregnation at normal pressure. The conditions of the impregnation are not particularly limited and may be appropriately selected depending on the kinds of the first insulating varnish, the enamel wire, and the like.

After being applied to the enamel wire, the first insulating varnish can be cured by heating. The heating temperature and the heating duration are not particularly limited and may be appropriately selected depending on the kinds of components of the first insulating varnish used. The heating temperature is generally 100 to 250° C., and the heating duration is 1 to 24 hours and preferably 0.5 to 20 hours. When the heating temperature and the heating duration are beyond the ranges above, the desired effects may not be obtained.

The heating and curing of the first insulating varnish may be performed either before or after winding the enamel wire around a slot of the stator iron core. The first insulating varnish does not need to be thoroughly cured and may be half-cured.

The method for winding the enamel wire around a slot of the stator iron core is not particularly limited and a method known in the technical field can be employed.

Subsequently, the second insulating varnish is applied to the resulting coil.

The method of application of the second insulating varnish is not particularly limited and a method known in the technical field can be employed. Specifically, the methods exemplified for application of the first insulating varnish, which employ impregnation, and dripping of the second insulating varnish onto the coil can be employed.

After being applied to the coil, the second insulating varnish can be cured by heating. The heating temperature and the heating duration are not particularly limited and may be appropriately selected depending on the kinds of components of the second insulating varnish used. The heating temperature is generally 100 to 250° C., and the heating duration is 1 to 24 hours and preferably 0.5 to 20 hours. When the heating temperature and the heating duration are beyond the ranges above, the desired effects may not be obtained.

The heating and curing of the second insulating varnish is continued until the second insulating varnish is completely cured. In particular, when the first insulating varnish has been half-cured, heating is continued until both the first insulating varnish and the second insulating varnish are completely cured.

The stator coil thus formed has an insulating layer with excellent adhesive strength to prevent thermal degradation of its enamel wire and has excellent dielectric strength properties retained for an extended period of time, thereby being useful as a stator coil for a rotating electrical machine.

### Embodiment 2

The stator coil for a rotating electrical machine of this embodiment differs from the stator coil for a rotating electrical machine of embodiment 1 in that a coil of a wound enamel wire is provided with a polyester resin coating that is formed by curing the first insulating varnish containing a polyester resin and then further providing the resulting polyester resin coating with an epoxy acrylate resin coating that is formed by curing the second insulating varnish containing an epoxy acrylate resin so as to form an insulating layer. The insulating layer thus formed can also contribute to improved adhesive strength of the insulating layer and improved dielectric strength properties retained for an extended period of time.

The polyester resin coating on the coil is effective as a stress mitigation layer and a layer to impart adhesive properties, as explained in the following. The polyester resin coating is not as hard as the epoxy acrylate resin coating that is the outermost layer and therefore can contribute to mitigating the stress between the enamel wire that constitutes the coil and the epoxy acrylate resin coating. In addition, the polyester resin coating has excellent compatibility with the enamel coating, and also has excellent compatibility with the epoxy acrylate resin coating because of the presence of an ester group therein that is also present in the epoxy acrylate resin coating. This contributes to enhanced adhesion between the enamel wire that constitutes the coil and the epoxy acrylate resin coating.

Further, the epoxy acrylate resin coating that is the outermost layer has a high crosslink density compared to the polyester resin coating, and this allows dielectric strength properties to be enhanced.

For these reasons, by providing the coil with the polyester resin coating that is formed by curing the first insulating varnish containing a polyester resin and then providing the polyester resin coating with the epoxy acrylate resin coating that is formed by curing the second insulating varnish containing an epoxy acrylate resin so as to form the insulating layer, the adhesive strength of the insulating layer can be enhanced enough to prevent thermal degradation of the enamel wire and excellent dielectric strength properties can be retained for an extended period of time.

The polyester resin coating and the epoxy acrylate resin coating are the same as those in the stator coil for a rotating electrical machine of embodiment 1, and therefore an overlapping explanation is omitted.

In the following, a method for producing the stator coil for a rotating electrical machine of this embodiment is explained.

First, the enamel wire is wound around a slot of a stator iron core to form a coil. The method for winding the enamel wire around a slot of the stator iron core is not particularly limited and a method known in the technical field can be employed.

Subsequently, the first insulating varnish is applied to the coil and heating is performed. The method of application of the first insulating varnish is not particularly limited and a method known in the technical field can be employed. Specifically, the methods employing impregnation exemplified in embodiment 1, such as vacuum impregnation, vacuum pressure impregnation, and impregnation at normal pressure, and dripping of the first insulating varnish onto the coil can be employed.

The heating temperature at which and the heating duration during which the first insulating varnish is heated are not particularly limited and may be appropriately selected depending on the kinds of components of the first insulating varnish used. The heating temperature is generally 100 to 250° C., and the heating duration is 1 to 24 hours and preferably 0.5 to 20 hours. When the heating temperature and the heating duration are beyond the ranges above, the desired effects may not be obtained. The first insulating varnish does not need to be completely cured by heating and may be half-cured by heating.

Subsequently, the second insulating varnish is applied to the resulting coil covered with the cured first insulating varnish.

The method of application of the second insulating varnish is not particularly limited and a method known in the technical field can be employed. Specifically, the same methods and the same conditions as for the first insulating varnish can be employed.

The heating temperature and the heating duration at which the second insulating varnish is heated are not particularly limited and may be appropriately selected depending on the kinds of components of the second insulating varnish used. The heating temperature is generally 100 to 250° C., and the heating duration is 1 to 24 hours and preferably 0.5 to 20 hours. When the heating temperature and the heating duration are beyond the ranges above, the desired effects may not be obtained.

The heating and curing of the second insulating varnish is continued until the second insulating varnish is thoroughly cured. In particular, when the first insulating varnish has been half-cured, heating is continued until both of the first insulating varnish and the second insulating varnish are completely cured.

The stator coil thus formed has an insulating layer with excellent adhesive strength to prevent thermal degradation of its enamel wire and has excellent dielectric strength properties retained for an extended period of time, thereby being useful as a stator coil for a rotating electrical machine.

### EXAMPLES

The present invention will be described in more detail by examples. The scope of the present invention, however, is not limited to these examples.

### Example 1

A first insulating varnish containing an epoxy-modified polyester and a second insulating varnish containing bisphenol A epoxy acrylate were used in the following test.

In conformance with JIS C2103, an enamel wire that had an enamel coating on its polyamide-imide coating was used to prepare a twisted pair and a helical coil. The twisted pair and the helical coil were then each impregnated with a first insulating varnish, followed by heating at 130° C. for 2 hours to form a polyester resin coating thereon. Subsequently, the resulting twisted pair and the resulting helical coil were impregnated with a second insulating varnish, followed by heating at 160° C. for 2 hours to form an epoxy acrylate resin coating thereon.

The resulting helical coil was subjected to measurement of adhesive strength in conformance with JIS C2103 by an autograph (AG-5000D manufactured by Shimadzu Corporation). The adhesive strength thus measured was 250 N, which confirmed that the insulating layer had excellent adhesive strength.

Then, the twisted pair thus formed was subjected to measurement of breakdown voltage by a breakdown voltage tester (manufactured by Yamayo Shikenki), and the breakdown voltage thus measured was 16 kV. The twisted pair, after 20 days at 260° C., was also subjected to measurement of breakdown voltage in the same manner as above, and the breakdown voltage thus measured was 12 kV. On the other hand, a twisted pair subjected to no varnish treatment with the first insulating varnish and the second insulating varnish (namely, an enamel wire in its original form) had a breakdown voltage of 5 kV. This confirmed that varnish treatment with the first insulating varnish and the second insulating varnish can provide excellent dielectric strength properties retained for an extended period of time.

Then, a container measuring 500 mm×300 mm×100 mm was charged with the first insulating varnish, and an enamel wire that had an enamel coating on its polyamide-imide coating was impregnated with the first insulating varnish. Subsequently, the resulting enamel wire was wound around a stator iron core, followed by heating at 130° C. for 2 hours to give a coil having a polyester resin coating formed on the surface of the enamel wire. The resulting coil was then impregnated with the second insulating varnish, followed by heating at 160° C. for 2 hours to give a stator coil having an epoxy acrylate resin coating formed on the surface of the coil.

The resulting stator coil was subjected to measurement of breakdown voltage by a breakdown voltage tester (manufactured by Yamayo Shikenki). The breakdown voltage thus measured was about twice the breakdown voltage of a conventional stator coil formed by impregnating a coil with an insulating varnish containing an epoxy-modified polyester and heating.

### Example 2

A test was conducted in the same manner as in Example 1 except that a first insulating varnish containing an imide-modified polyester was used. As a result, the adhesive strength of the helical coil was 220 N and the breakdown voltage of the twisted pair was 15.5 kV. In addition, the breakdown voltage of the twisted pair after 20 days at 260° C. was 11.5 kV. These results confirmed that the varnish treatment in this example was able to enhance the adhesive strength of the insulating layer and provide excellent dielectric strength properties retained for an extended period of time.

Next, a stator coil was formed in the same manner as in Example 1 except that a first insulating varnish containing an imide-modified polyester was used, and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Example 3

A test was conducted in the same manner as in Example 1 except that a first insulating varnish containing a silicone-modified polyester and a second insulating varnish containing bisphenol F epoxy acrylate were used. As a result, the adhesive strength of the helical coil was 200 N and the breakdown voltage of the twisted pair was 15 kV. In addition, the breakdown voltage of the twisted pair after 20 days at 260° C. was 12 kV. These results confirmed that the varnish treatment in this example was able to enhance the adhesive strength of the insulating layer and provide excellent dielectric strength properties retained for an extended period of time.

Then, a stator coil was formed in the same manner as in Example 1 except that a first insulating varnish containing a silicone-modified polyester and a second insulating varnish containing bisphenol F epoxy acrylate were used, and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Example 4

A test was conducted in the same manner as in Example 1 except that a first insulating varnish containing a THEIC-modified polyester resin was used. As a result, the adhesive strength of the helical coil was 230 N and the breakdown voltage of the twisted pair was 15.5 kV. In addition, the breakdown voltage of the twisted pair after 20 days at 260° C. was 10 kV. These results confirmed that the varnish treatment in this example was able to enhance the adhesive strength of the insulating layer and provide excellent dielectric strength properties retained for an extended period of time.

Then, a stator coil was formed in the same manner as in Example 1 except that a first insulating varnish containing a THEIC-modified polyester resin was used, and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Example 5

A test was conducted in the same manner as in Example 1 except that heat treatment of a first insulating varnish was performed at 100° C. for 30 minutes. As a result, the adhesive strength of the helical coil was 230 N and the breakdown voltage of the twisted pair was 15.5 kV. In addition, the breakdown voltage of the twisted pair after 20 days at 260° C. was 12 kV. These results confirmed that the varnish treatment in this example was able to enhance the adhesive strength of the insulating layer and provide excellent dielectric strength properties retained for an extended period of time.

Then, a stator coil was formed in the same manner as in Example 1 except that heat treatment of a first insulating varnish was performed at 100° C. for 30 minutes, and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Example 6

A test was conducted in the same manner as in Example 4 except that a first insulating varnish was subjected to vacuum impregnation (at a pressure of 0.1 mmHg or lower for 120 minutes). As a result, the adhesive strength of the helical coil was 230 N and the breakdown voltage of the twisted pair was 15.5 kV. In addition, the breakdown voltage of the twisted pair after 20 days at 260° C. was 11 kV. These results confirmed that the varnish treatment in this example was able to enhance the adhesive strength of the insulating layer and provide excellent dielectric strength properties retained for an extended period of time.

Then, a stator coil was formed in the same manner as in Example 4 except that a first insulating varnish was subjected to vacuum impregnation (at a pressure of 0.1 mmHg or lower for 120 minutes), and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Example 7

A test was conducted in the same manner as in Example 1 except that a first insulating varnish was subjected to vacuum pressure impregnation (vacuum impregnation at a pressure of 0.1 mmHg or lower for 120 minutes, followed by pressurization at a pressure of 3 kg/cm² for 180 minutes). As a result, the adhesive strength of the helical coil was 200 N and the breakdown voltage of the twisted pair was 16 kV. In addition, the breakdown voltage of the twisted pair after 20 days at 260° C. was 10 kV. These results confirmed that the varnish treatment in this example was able to enhance the adhesive strength of the insulating layer and provide excellent dielectric strength properties retained for an extended period of time.

Then, a stator coil was formed in the same manner as in Example 1 except that a first insulating varnish was subjected to vacuum pressure impregnation (vacuum impregnation at a pressure of 0.1 mmHg or lower for 120 minutes, followed by pressurization at a pressure of 3 kg/cm² for 180 minutes), and the breakdown voltage thereof was measured. As a result, the breakdown voltage of the stator coil formed in this example was about twice the breakdown voltage of a conventional stator coil formed by impregnating a coil with an insulating varnish containing an epoxy-modified polyester and heating.

### Comparative Example 1

A test was conducted in the same manner as in Example 1 except that a first insulating varnish containing an epoxy resin was used. As a result, the adhesive strength of the helical coil was 250 N and the breakdown voltage of the twisted pair was 16 kV. In addition, the breakdown voltage of the twisted pair after 20 days at 260° C. was 4 kV, indicating that the breakdown voltage decreased significantly at high temperatures. This result confirmed that the varnish treatment in this comparative example was able to enhance the adhesive strength of the insulating layer but unable to provide excellent dielectric strength properties retained for an extended period of time.

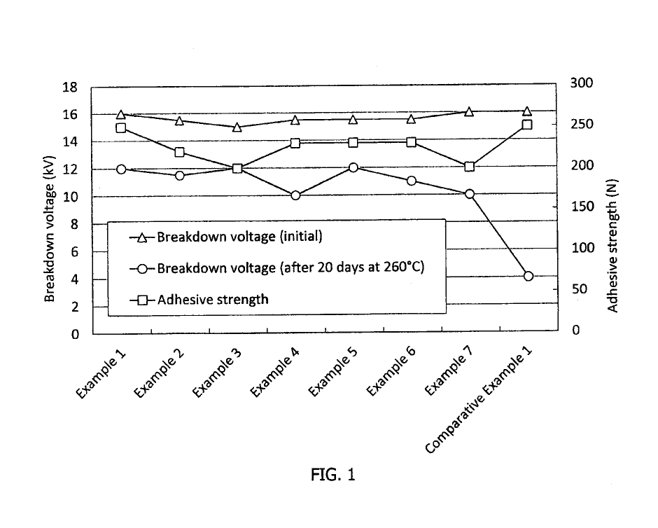

The values of the adhesive strength, the initial breakdown voltage, and the breakdown voltage after 20 days at 260° C. in the examples and the comparative example are plotted in FIG. 1. As shown in FIG. 1, in Examples 1 to 7, all of the adhesive strength, the initial breakdown voltage, and the breakdown voltage values after 20 days at 260° C. were high. In contrast to this, in Comparative Example 1, although the adhesive strength and the initial breakdown voltage were high, the breakdown voltage after 20 days at 260° C. was significantly low.

As indicated by these results, the present invention can provide a stator coil for a rotating electrical machine, the stator coil having an insulating layer with excellent adhesive strength to prevent thermal degradation of its enamel wire, and having excellent dielectric strength properties retained for an extended period of time; a method for producing the stator coil; and a rotating electrical machine having these properties.

1-5. (canceled)

6. A stator coil for a rotating electrical machine, the stator coil comprising a stator iron core and a coil formed by winding an enamel wire covered with an enamel coating around a slot of the stator iron core, wherein
the enamel wire is further covered with a cured product of a first insulating varnish containing a polyester resin, and
the coil is covered with a cured product of a second insulating varnish containing an epoxy acrylate resin.

7. The stator coil according to claim 6, wherein the enamel coating is a polyamide-imide coating.

8. A stator coil for a rotating electrical machine, the stator coil comprising a stator iron core and a coil formed by winding an enamel wire covered with an enamel coating around a slot of the stator iron core, wherein
the coil is covered with a cured product of a first insulating varnish containing a polyester resin, and
the cured product of a first insulating varnish is covered with a cured product of a second insulating varnish containing an epoxy acrylate resin.

9. The stator coil according to claim 8, wherein the enamel coating is a polyamide-imide coating.

10. A method for producing a stator coil for a rotating electrical machine, comprising:
a first step of applying a first insulating varnish containing a polyester resin to an enamel wire covered with an enamel coating,
a second step of winding the enamel wire obtained by the first step around a slot of a stator iron core to form a coil, and
a third step of applying a second insulating varnish containing an epoxy acrylate resin to the coil obtained by the second step.

11. The method for producing a stator coil for a rotating electrical machine according to claim 10, wherein
application of the first insulating varnish and the second insulating varnish are performed by vacuum impregnation, vacuum pressure impregnation, or impregnation at normal pressure.

12. The method for producing a stator coil according to claim 10, wherein the enamel coating is a polyamide-imide coating.

13. A method for producing a stator coil for a rotating electrical machine, comprising:
a first step of winding an enamel wire covered with an enamel coating around a slot of a stator iron core to form a coil,
a second step of applying a first insulating varnish containing a polyester resin to the coil obtained by the first step and performing heating, and
a third step of applying, to the coil obtained by the second step, a second insulating varnish containing an epoxy acrylate resin and performing heating.

14. The method for producing a stator coil for a rotating electrical machine according to claim 13, wherein
application of the first insulating varnish and the second insulating varnish are performed by vacuum impregnation, vacuum pressure impregnation, or impregnation at normal pressure.

15. The method for producing a stator coil according to claim 13, wherein the enamel coating is a polyamide-imide coating.

16. A rotating electrical machine comprising the stator coil for a rotating electrical machine according to claim 6.

17. A rotating electrical machine comprising the stator coil for a rotating electrical machine according to claim 8.
